(19) United States
(12) Patent Application Publication
(10) Pub. No.: US 2003/0062722 A1
(43) Pub. Date: Apr. 3, 2003

(54) Hose line with a connection sleeve

(76) Inventor: Georg Peter Linhart, Wollstadt, DE (US)

Correspondence Address: HORST M. KASPER, 13 FOREST DRIVE, WARREN, NJ, 07059, US

(21) Appl. No.: 10/225,525

(22) Filed: Aug. 21, 2002

(30) Foreign Application Priority Data
Aug. 21, 2001 (DE) 201 13 222.2

(51) Int. Cl. F16L 33/00

(52) U.S. Cl. 285/319; 285/903; 285/921; 285/251

(57) ABSTRACT

A hose connection comprises a hose (1), an elastic sleeve (2), a connection tube (3) and a stiff ring (4). The hose (1) is made of a thermoplastic material and has a smooth surface on the inside and exhibits helically formed running wave valleys and wave mountains on the outside. The elastic sleeve (2) is fixedly connected to the hose (1) and carried at one end of the hose (1) and has a front end. The connection tube (3) has recesses 3(a). The elastic sleeve (2) engages into the connection tube (3) in the destined position of the elastic sleeve (2). The elastic sleeve (2) is at its front end furnished with a sealing lip (2a) formed for sealing of the sleeve (2) against the connection tube (3). The sleeve (2) is gripped around by the stiff ring (4) axially fixed disposed on the sleeve (2) and made of a thermoplastic material and is axially aligned. At least two tongues (4a) are formed into the stiff ring (4) with roots, wherein the tongues (4a) are spring supported around the roots of the tongues (4a) for lockingly engaging into the recesses (3a) of the connection tube (3).

### BACKGROUND OF THE INVENTION

1. Field of the Invention

The invention relates to a hose line with a connection sleeve, wherein the hose made of thermoplastic material business moves on the inside, and exhibits on the outside, helical running wave valleys and wave mountains. Furthermore at one end it carries a fixedly connected elastic sleeve.

2. Brief Description of the Background of the Invention Including Prior Art

Hose connections of the recited kind are already known. The sealing lip of the elastic sleeve performs, in this case, the function to seal the sleeve against the connection pipe by gripping behind a radial bead in the destined position of the sealing lip. If the sleeve and/or the hose are moved more or less strong, then the sealing effect of the sealing lip can be interfered with.

### SUMMARY OF THE INVENTION

1. Purposes of the Invention

It is an object of the present invention to form the hose line, of the above-recited kind, such that the sealing effect of the sealing lip also then remains intact when the hose and/or the connection tube are moved more or less strongly.

These and other objects and advantages of the present invention will become evident from the description which follows.

2. Brief Description of the Invention

The present invention provides that a sealing structure of the sleeve is limited to its sealing function according to the construction of the present invention and is no longer part of a disengageable connection between the hose and the connection tube. The function of the disengageable connection between the hose and the connection tube is now shifted to a stiff ring with spring-supported tongues, wherein the spring-supported tongues in their destination position are locked into the corresponding recesses of the connection tube.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing. An embodiment of the invention is schematically illustrated in the drawing.

### BRIEF DESCRIPTION OF THE DRAWING

In the accompanying drawing, in which is shown one of the various possible embodiments of the present invention:

FIG. 1 is a longitudinal sectional view of a hose, a sleeve connected to the hose and the connection tube disengageably connected to the sleeve,

FIG. 2 is a perspective view of a ring with spring-supported tongues,

FIG. 3 is a side elevational view of the embodiment of FIG. 1.

### DESCRIPTION OF INVENTION AND PREFERRED EMBODIMENT

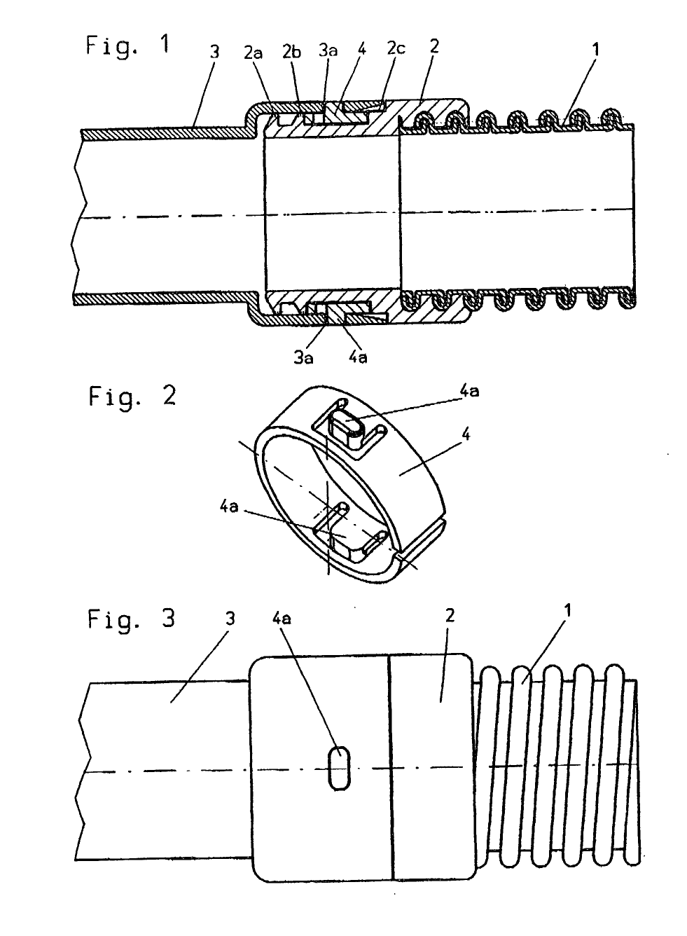

A hose comprising thermoplastic material is shown in FIGS. 1 and 3 and designated with reference numeral 1, wherein the hose is smooth on the inside surface and exhibits on the outside helically running wave mountains and wave valleys.

The hose 1 carries at its end an elastic sleeve 2 solidly connected to the hose 1, wherein the sleeve 2 can be screwed onto the hose 1 or can be molded to the hose 1. The sleeve 2 in its destined position engages into a connection tube 3. A sealing lip 2a is formed at the front end of the sleeve 2, wherein the sleeve 2 is able to be sealed against the connection tube 3 with this sealing lip 2a.

The sleeve 2 is surrounded by and gripped around by an axial stiff ring 4, is made of a thermoplastic material, wherein the stiff ring 4 is axially fixed in its destined position between a bead 2b and a circulating shoulder 2c of the sleeve 2. The bead 2b and the shoulder 2c are disposed between the attachment of the sleeve 2 on the hose 1 and the sealing lip 2. The ring 4 is furnished with two tongues 4a that are spring supported around their roots, wherein the tongues 4a are formed for a locking into the recesses 3a of the connection tube 3. The sealing lip 2a in this fashion is freed from the function to be part of a disengageable connection between the hose 1 and the connection tube 3. The sealing lip 2 serves exclusively and is limited to the sealing function.

The ring 4 can be brought into its destined position by radially compressing together the sleeve 2. If the ring 4 is slotted in the longitudinal direction, then the ring 4 can also, however, be bent apart in order to be brought into its destined position.

It will be understood that each of the elements described above, or two or more together, may also find a useful application in other types of hose line system configurations and hose connecting procedures differing from the types described above.

While the invention has been illustrated and described as embodied in the context of a hose line with a connection sleeve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A hose connection with a connection sleeve, wherein the hose (1) made of a thermoplastic material is smooth on the inside and exhibits helically formed running wave valleys and wave mountains on the outside and furthermore carries at one end an elastic sleeve (2) fixedly connected to the hose (1), wherein the elastic sleeve (2) engages into a connection tube (3) in the destined position of the elastic sleeve (2) and wherein the elastic sleeve (2) is at its front end furnished with a sealing lip (2a) formed for sealing of the sleeve (2) against the connection tube (3), wherein the sleeve (2) is gripped around by a stiff ring (4) axially fixed disposed on the sleeve (2) and made of a thermoplastic material and axially aligned, wherein at least two tongues (4a) are formed into the stiff ring (4), wherein the tongues (4a) are spring supported around the roots of the tongues (4a) for lockingly engaging into recesses (3a) of the connection tube (3).

2. The hose connection according to claim 1 wherein the ring (4) is axially fixed between a bead (2b) and a circulating shoulder (2c) of the sleeve (2), and wherein the bead (2b) and the shoulder (2c) are disposed between the attachment of the sleeve (2) on the hose (1) and the sealing lip (2a).

3. The hose connection according to claim 1 wherein the ring (4) is slotted in longitudinal direction.

4. The hose connection according to claim 1, wherein the sleeve (2) is screwed onto the hose (1).

5. The hose connection according to claim 1 wherein the sleeve (2) is molded onto the hose (1).

6. A hose connection comprising
a hose (1) made of a thermoplastic material having a smooth surface on the inside and exhibiting helically formed running wave valleys and wave mountains on the outside;
an elastic sleeve (2) fixedly connected to the hose (1) and carried at one end of the hose (1) and having a front end;
a connection tube (3) having recesses 3(a), wherein the elastic sleeve (2) engages into the connection tube (3) in the destined position of the elastic sleeve (2) and wherein the elastic sleeve (2) is at its front end furnished with a sealing lip (2a) formed for sealing of the sleeve (2) against the connection tube (3);
a stiff ring (4), wherein the sleeve (2) is gripped around by the stiff ring (4) axially fixed disposed on the sleeve (2) and made of a thermoplastic material and axially aligned;
at least two tongues (4a) formed into the stiff ring (4) with roots, wherein the tongues (4a) are spring supported around the roots of the tongues (4a) for lockingly engaging into the recesses (3a) of the connection tube (3).

7. The hose connection according to claim 6 wherein the stiff ring (4) is axially fixed between a bead (2b) and a circulating shoulder (2c) of the sleeve (2), and wherein the bead (2b) and the shoulder (2c) are disposed between an area of attachment of the sleeve (2) to the hose (1) and the sealing lip (2a).

8. The hose connection according to claim 6 wherein the ring (4) is open and interrupted.

9. The hose connection according to claim 6, wherein the sleeve (2) is screwed onto the hose (1).

10. The hose connection according to claim 6 wherein the sleeve (2) is molded onto the hose (1).
